(19) United States
(12) Patent Application Publication
(10) Pub. No.: US 2014/0351868 A1
(43) Pub. Date: Nov. 27, 2014

(54) ON-BOARD COMMUNICATION DEVICES FOR A CAB OF A VEHICLE, EACH WITH A MEDIA SERVER AND A RADIO MODULE BY MEANS OF WHICH THE DEVICES ARE CONNECTED TO ONE ANOTHER IN A WIRELESS FASHION

(71) Applicant: LUFTHANSA TECHNIK AG, HAMBURG (DE)

(72) Inventors: Gerko Wende, Hamburg (DE); Frank Niss, Hamburg (DE); Alexander Goessel, Hamburg (DE); Andrew Muirhead, Norderstedt (DE)

(21) Appl. No.: 14/372,196

(22) PCT Filed: Dec. 19, 2012
(86) PCT No.: PCT/EP2012/005250

§ 371 Date: Jul. 14, 2014

(30) Foreign Application Priority Data
Jan. 13, 2012 (DE) 10 2012 200 487.4

(51) Int. Cl. H04N 21/414; H04N 21/214

(52) U.S. Cl. CPC H04N 21/41422; H04N 21/2146
USPC 725/75

(57) ABSTRACT

Embodiments relate to an on-board communication device, a plurality of communication devices, a communication system for a passenger compartment of a vehicle, and/or a vehicle having a passenger compartment and a communication system, wherein the on-board communication device comprises at least one media server and at least one wireless data access point with a radio unit for wireless transmission of media data from the media server of the on-board communication device to at least one passenger device, such as in the passenger compartment, where the on-board communication device has at least one radio module for wireless communication of the on-board communication device with a further on-board communication device.

The invention relates to an on-board communication device and system for a passenger compartment of a vehicle, wherein the on-board communication device comprises at least one media server and at least one wireless data access point with a radio unit for wireless transmission of media data from the media server of the on-board communication device to at least one passenger device in the passenger compartment.

In passenger compartments of vehicles for passenger transportation, such as for example aircraft cabins, entertainment and communication systems are used which offer the passengers entertainment content in the form of e.g. films and music, and communications content, such as radio, television, telephone and Internet access. This content can be made accessible to the passengers via wired on-board devices. This can be done, for example, by means of screens in the passenger compartment for a plurality of passengers or on individual at-seat screens.

For further individualisation, entertainment or media content can be transmitted to passenger devices for entertainment purposes during the journey time. The passenger devices are devices which are suitable for communication purposes or for displaying media content. They are brought along by the passengers and may be of different types and models. Typical passenger devices are laptops, tablet PCs and smartphones. Such entertainment systems regularly consist of a media server, in which the corresponding media content is stored and the data processing takes place, and of wireless access points in the passenger compartment which are connected to the media server in a cabled network. The passenger devices are connected to the media server via the wireless data access point, so that the passengers can select and use media content via their passenger devices.

An entertainment system of this type involves a high installation effort for obtaining the necessary cabling between the individual components, such as the media server and the wireless data access points which are distributed throughout the vehicle. This cabling is very time-consuming: this is the case in particular for aircrafts owing to the more stringent demands and the certification under aviation regulations which is additionally necessary.

Generally, cabling of individual components which are mounted distributed throughout the aircraft, in order to make possible appropriate coverage or supply of wireless data access points in the whole cabin, above all when upgrading an entertainment system, is very time-consuming. Furthermore, the additional weight introduced into the vehicle by the cabling, in particular in the case of aircrafts, is disadvantageous. The number of different components is disadvantageous for exchange and repair of components, since all the components have to be held available as spare parts.

The object of the invention is to devise an on-board communication device and system for a passenger compartment of a vehicle which is distinguished by low weight, simple installation and maintainability.

This object is achieved starting from the preamble of claim 1 in conjunction with the characterising features thereof. An on-board communication device for a passenger compartment of a vehicle comprises at least one media server and at least one wireless data access point with a radio unit for wireless transmission of media data from the media server of the on-board communication device to at least one passenger device in the passenger compartment. According to the invention, the on-board communication device has at least one radio module for wireless communication of the on-board communication device with a further on-board communication device.

A radio module according to the invention for wireless communication of the on-board communication device with a further on-board communication device is particularly advantageous because wireless communication or wireless networking between a plurality of on-board communication devices in a vehicle which is independent of wireless data connections to passenger devices via the wireless data access point is possible. The operation of the radio module can take place in the on-board communication device preferably independently of the operation of the radio unit. The radio module is therefore preferably independent of the radio unit.

The suitability of the radio module for wireless communication with at least one further on-board communication device has the advantage that the installation and maintenance effort is minimised. A complex cabling of individual components which have to be installed distributed throughout the vehicle for wireless network coverage can be dispensed with. Furthermore, due to the integration of the media server and the wireless data access point cabling work between these units is likewise avoided. Furthermore, overall the redundancy of the system with respect to for example failure of individual on-board communication devices and corrupt data sets on storage media of an on-board communication device is increased. In addition, the use of only one on-board communication device results in greatly simplified maintainability, supply of spare parts and replaceability.

Preferably, wireless data exchange with at least one further identically constructed on-board communication device can be carried out with the on-board communication device without restrictions on the possible transfer rates of wireless data transmissions between the on-board communication device and passenger devices.

The media server can be designed to be smaller and more cost-effective, since one media server does not have to read out and distribute all the media data for a very large number of passenger devices in parallel. The media server is designed for a number of possible passengers or passenger devices, the performance capability of the media server being adapted to the possible wireless coverage. The performance capability in this case is preferably independent of the volume of data which can be stored. If the number of passengers or the number of passenger devices in the vehicle exceeds the performance capability of an on-board communication device, the vehicle can be adapted to the required performance capability by a further on-board communication device.

Using a radio unit of the wireless data access point for the transmission of media content, such as films and music, and an independent radio module for the communication with other on-board communication devices makes communication possible without any restriction of the data connection or transfer rates to the passenger devices, so that even in the case of simultaneous communication with other on-board communication devices it is possible for the passenger devices to have a constant connection quality for loading media content from the media server of the on-board communication device, which is of particular significance in order to ensure a constantly good connection quality.

In an advantageous embodiment, the radio module and the radio unit have different frequency ranges. Different frequency ranges of the radio module and radio unit are advantageous for the on-board communication device because independent operation without mutual negative interference can be achieved in a simple manner due to the clear separation of the frequencies.

In a further advantageous embodiment, the radio unit of the wireless data access point and the radio module have different channels and/or data protocols, which is advantageous for an independent data connection to a passenger device and to further on-board communication devices, so that a high data transfer rate can be achieved with both types of communication peers.

In a preferred embodiment, at least one on-board communication device in the vehicle is connected to an on-board communication means of the vehicle for external data connections. On-board communication means may be various technical devices for setting up an external data connection, which make for example a communication link to the Internet possible during operation of the vehicle. An on-board communication means of this type differs from the connection of passenger devices to an external data connection, which are frequently also configured to set up external data connections, by an increased performance capability relative to the possible range of the radio link. A satellite-aided external data connection is of particular advantage, since during a vehicle's journey, owing to the spatial distance from potential radio stations or radio masts which the passenger devices might usually use to set up an external data connection, an external data connection may not be possible, or may be possible only to a limited extent. This is significant in particular if the vehicle is a ship or aircraft which is moving across large areas of water, where typically no or fewer ground-based radio stations are available. Ultimately, however, ground-to-air data connections are not ruled out.

Preferably the on-board communication device is a switching unit for a wireless data connection between at least two identically constructed on-board communication devices in the vehicle. An integrated functionality as a switching unit is advantageous because, due to the connection of an on-board communication device to an on-board communication means, each on-board communication device in the vehicle can access the external data connection of the on-board communication means. The independent radio module for wireless communication of the on-board communication devices with each other is advantageous for this because, owing to its function as a switching unit, data-intensive transmission of media content from the media server, e.g. films, to the passenger devices using the radio unit of the wireless data access point is not adversely affected.

Furthermore, the on-board communication device is preferably a switching unit for at least one wireless data connection between at least one passenger device and the on-board communication means for an external data connection. The on-board communication device as a switching unit can make the external data connection available to at least one passenger device for incoming and/or outgoing data connections, so that the passengers can have access to large data networks, such as for example the Internet or the telephone network, with their passenger devices while they remain in the vehicle.

In an advantageous embodiment, the on-board communication device is configured to be switched on and/or off by means of a control line. The control line serves to transmit a switching command to the on-board communication device, which command can be given e.g. by an operating means in the vehicle. Alternatively, the on-board communication device may for example be switched on and off by switching the power supply of the on-board communication device on and off.

Preferably the on-board communication device is configured to be switched on and/or off by a ripple control via the power supply of the on-board communication device. A ripple control is a transmission of control commands by deliberately varying the voltage of the power supply over time. This is advantageous because, due to the ripple control, simple control commands can be transmitted to the on-board communication device without a control line being necessary for controlling the on-board communication device in addition to the power connection in the vehicle.

The on-board communication device in an advantageous embodiment is configured to switch the send functions of the radio units and/or radio modules on or off automatically once a particular signal has been received. The on-board communication device is not necessary for safe operation of the vehicle, so lesser safety and redundancy demands can be made on it. However, especially in the field of air travel, particular demands apply in terms of electromagnetic compatibility in order to rule out endangering aircraft operations by interference on electronic devices, such as aircraft instrumentation. The take-off and landing phases of an aircraft are regarded as particularly critical, so during these phases operation of radio devices in the passenger area is currently not permitted. The passengers as a rule are requested to switch off their electronic devices during these phases of flight. The on-board communication device is not necessary for aircraft operations, so this device should likewise be switched off during these phases of flight. Simple automatic switching-off of the send functions is possible by means of a particular signal. Such a signal may for example, in an advantageous embodiment, be a radio signal. The send function can be switched on once the critical phase of flight has been concluded, so that communication with the passenger devices can be commenced in order to increase travelling comfort.

Preferably the on-board communication device is configured to emit a radio signal for switching the radio units and/or radio modules of at least one further on-board communication device in the vehicle on or off. This means that one on-board communication device in the vehicle can switch on or off all the other on-board communication devices, as a result of which it is possible to control all the on-board communication devices by means of one on-board communication device to which an operating means can be connected. This simplifies handling when using a plurality of on-board communication devices in a vehicle, so that central control of a plurality of or all of the on-board communication devices in the vehicle is possible.

Furthermore, a signal received in an on-board communication device can be routed before the command contained therein, e.g. to switch off the send functions, is executed, in order for example to bridge greater distances in the passenger compartment from other on-board communication devices.

The on-board communication device in an advantageous embodiment is configured to be switched on or off by switching the power supply on or off. This possibility of switching the operating state permits simple and reliable switching-off, so that e.g. aviation regulations can be complied with in a simple manner.

Preferably the on-board communication device is completely ready for operation in less than 2 minutes once the power supply has been switched on. The on-board communication device has a media server which after an unannounced interruption in the power supply powers up again when the power supply is switched on in the case of what is called a cold start. During this time, the media server and/or the on-board communication device is/are not fully ready for operation, and therefore a short start time of less than 2 minutes is preferred.

In an advantageous embodiment, the on-board communication device is configured to identify its installation location in the vehicle by means of coding of an installation-side plug connector of the vehicle to the power supply. Coding of the plug connector on the vehicle side makes device-independent identification of the installation location in the vehicle possible, so that for example corresponding configurations of the on-board communication device can be effected by means of the coding of the plug connector. This considerably simplifies replacing an on-board communication device, since the on-board communication device after installation no longer has to be configured, and the service technician who carries out the replacement only has to carry out a direct mechanical exchange of the entire device. Information in the coding which goes beyond the installation location in the aircraft may for example be coding for communication with other on-board communication devices in the vehicle, so that with the coding by the plug connector a further exchange of communications and hence also a configuration of the replacement or new device by another on-board communication device can take place.

Updated media data can advantageously be transmitted into the on-board communication device using a mobile media-loading unit. The media content in the on-board communication device is typically updated at certain intervals in order to be able to make current and topical media content available to the passengers. This is done in an advantageous embodiment by means of a media loading unit which can transmit updated media content wirelessly or by cable to an on-board communication device. The transmission typically takes place during interruptions in operation of the vehicle. In alternative embodiments, it is possible to load media data via an Internet connection during operation or during interruptions in operation of the vehicle.

Preferably the on-board communication device is configured for automatic transmission of updated media data from the media server to further on-board communication devices in the vehicle. This results in the possibility of transmitting updated media data to only one on-board communication device in the vehicle, which makes the necessary operating expenditure for the loading operation using one media loading unit independent of the number of on-board communication devices in the vehicle which are used. The updated media content is transmitted to all the other on-board communication devices using the wireless data connection between a plurality of on-board communication devices in the vehicle. The outdated media content can be overwritten or deleted for this. Furthermore, in this manner it can be ensured that all the on-board communication devices in the vehicle have the same media content. Furthermore, owing to the distribution of the media data the operating reliability increases without additional back-up means.

The object of the invention is furthermore achieved by an on-board communication system for a passenger compartment of a vehicle, wherein the on-board communication system comprises a plurality of identically constructed on-board communication devices, as described above, which are connected together to form a wireless network.

A plurality of on-board communication devices is advantageous because this makes possible sufficient and uniform coverage with a sufficient connection quality to the next wireless data access point for the passenger devices in the entire passenger compartment. This is advantageous in particular for larger passenger compartments, above all for elongate passenger compartments, in order to achieve a wireless network connection which is as good as possible for all the passenger devices.

The on-board communication system makes it possible to transmit media data which is stored in the on-board communication devices, and to provide external data connections for a plurality of passenger devices, so that the passengers can make use of these opportunities with the devices which they have brought along themselves, and with which they are familiar.

The on-board communication system, owing to the connection to a wireless network, is easy to install in the vehicle. Above all, it is possible to adapt the on-board communication system simply to the requirement of performance capability and to the spatial distribution of the users or operated passenger devices in the passenger compartment of the vehicle. Additional on-board communication devices can be integrated very simply due to the design of the on-board communication system with identically constructed on-board communication devices, in order for example to meet increased demands in terms of transmission speed. Owing to the use of only one system component, the on-board communication device, the effort of installation and maintenance of the on-board communication system is very low.

The invention will be explained below using preferred embodiments with reference to the appended figures. Therein:

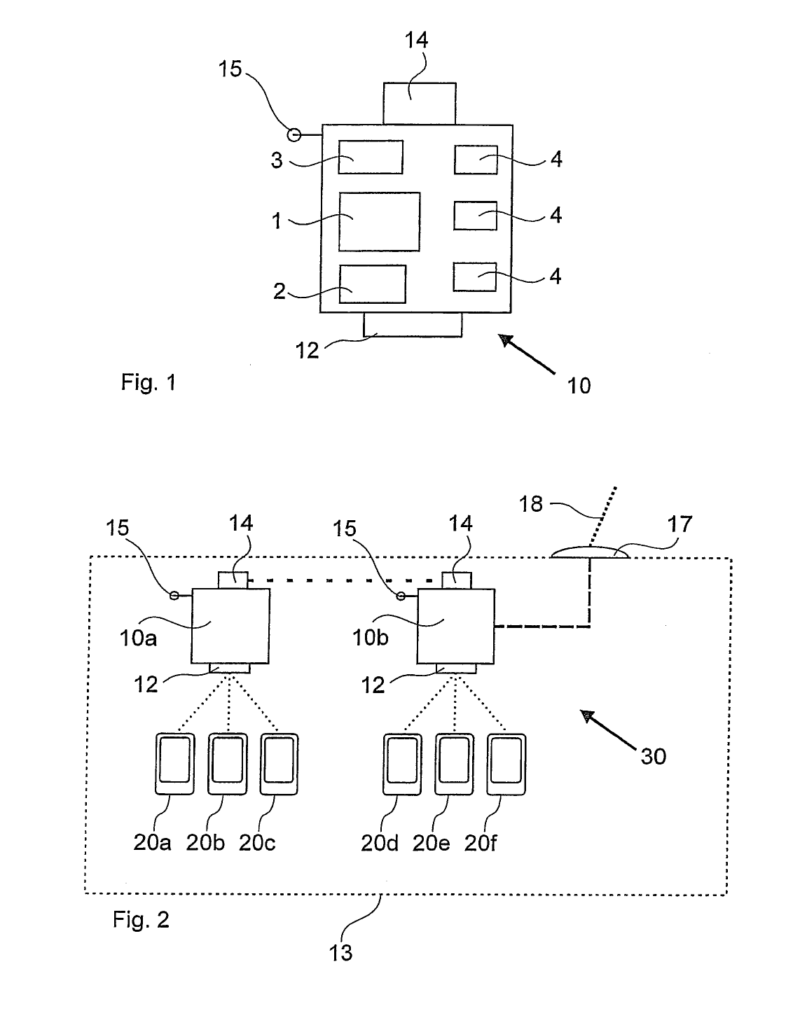

FIG. 1 shows a diagrammatic representation of the setup of an on-board communication device;

FIG. 2 shows a diagrammatic representation of two on-board communication devices in the passenger compartment of a vehicle;

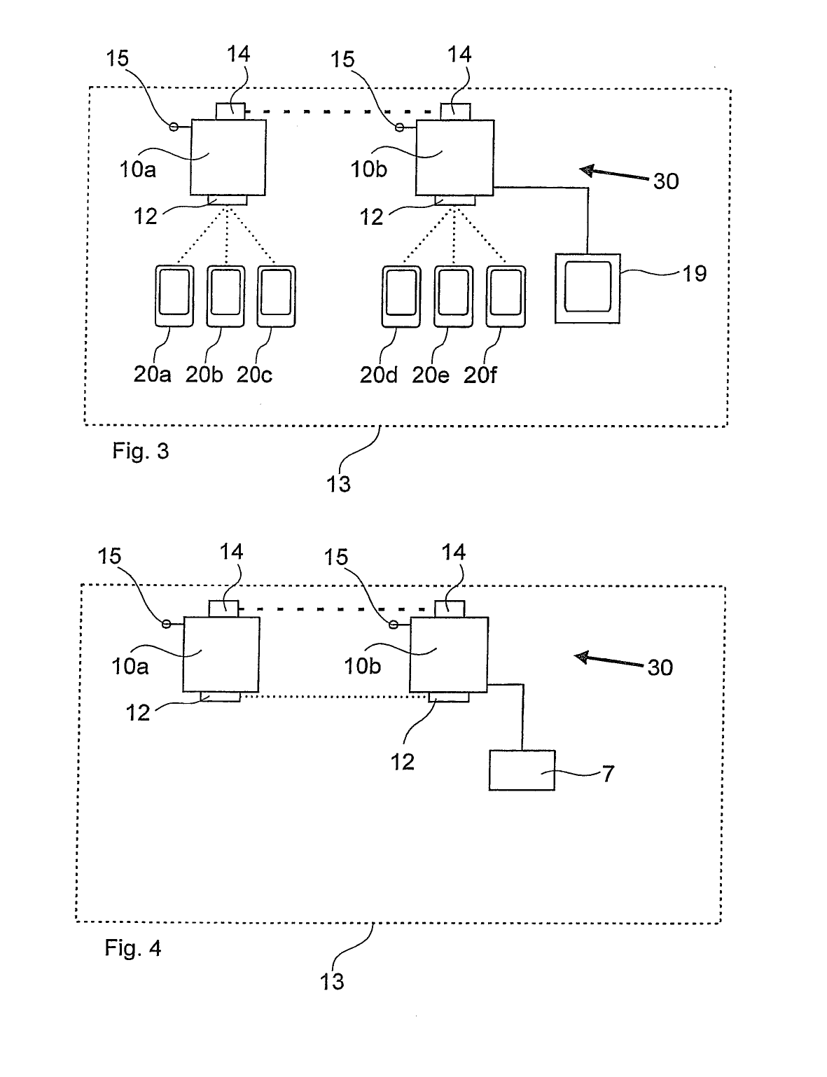

FIG. 3 shows a diagrammatic representation of an on-board communication device with operator terminal; and

FIG. 4 shows a diagrammatic representation of an on-board communication device with a mobile media-loading unit.

FIG. 1 diagrammatically shows an embodiment of an on-board communication device 10. The on-board communication device 10 has a media server 1 which serves to process data and to control the on-board communication device 10. In particular, the media server 1 serves to manage and make available media data and configuration data. The media server 1 may be a typical computer module which is adapted to the requirement in the on-board communication device 10.

A memory unit 2, in which the corresponding media data and configuration data can be stored, is connected to the media server 1. In an advantageous embodiment, the memory unit 2 is a bulk storage device which is insensitive to mechanical vibrations, such as a solid-state drive or alternatively semiconductor hard drive.

The on-board communication device 10 has a wireless data access point with a radio unit 12, via which the on-board communication device 10 can communicate with the passenger devices 20 of the people who are located in a vehicle 13, and can transmit data. For this, the wireless standards usually supported for the passenger devices 20 are used, such as for example IEEE 802.11a/b/g/n, known as wireless LAN. Furthermore, for example typical mobile radio standards such as GSM, UMTS and LTE, and also IEEE 802.16 (WiMax) can be used.

Furthermore, the on-board communication device 10 has a radio module 14 which can be operated independently from the radio unit 12. For this, the same standards may be used as for the radio unit 12. In a preferred embodiment, the radio unit 12 and the radio module 14 however have different frequency ranges. These different frequency ranges may for example be a frequency band at 2.4 GHz and a frequency band at 5 GHz. Furthermore, the channels and protocols of the radio unit 12 and radio module 14 may differ, so that mutual negative interference between the two is avoided. In an advantageous embodiment, the radio module 14 uses the IEEE 802.16 wireless standard. Alternatively, other wireless standards may also be used, such as for example IEEE 802.11.

The radio unit 12 and/or the radio module 14 may in each case have a plurality of sending and receiving antennas. Furthermore, the radio unit 12 and the radio module 14 typically support what is called MIMO technology in order to utilise the frequency bandwidth optimally. The radio unit 12 and the radio module 14 have corresponding antennas, which are preferably integrated into the on-board communication device 10.

In this embodiment, the on-board communication device 10 has a voltage source 3 which generates all the electrical voltages required in the on-board communication device 10 from the power supply 15 of the vehicle 13.

Furthermore, the on-board communication device 10 in this embodiment has various interface modules 4 for connecting various optional devices. The interface modules 4 can make possible the connection of simple digital inputs and outputs, and/or connection in accordance with usual standards, such as for example RS232, USB, Ethernet, VGA, DVI and HDMI.

FIG. 2 shows, in a diagrammatic representation of an embodiment, an on-board communication system 30 with two on-board communication devices 10 in a passenger compartment of a vehicle 13. The on-board communication devices 10 are installed in the vehicle 13 at locally separated positions and are connected to a power supply 15 of the vehicle 13. There is a wireless data connection between the two on-board communication devices 10, as a result of which the installation effort is very low. Furthermore, the on-board communication system 30 is lighter due to the savings on cabling between the devices, which is advantageous in particular for an aircraft, owing to the reduced fuel consumption or the higher possible load capacity.

In a possible embodiment, the on-board communication device 10 recognises the installation location and the corresponding configuration, which may comprise e.g. channels or radio codings used, by means of coding of the plug connector to the power supply 15 of the vehicle 13.

The on-board communication devices 10 make media content, which is stored in the on-board communication device 10, available to the passengers on their passenger devices 20 via the wireless data access point. The passengers can thereby utilise the media offering made available by the vehicle operator while they remain in the passenger compartment of the vehicle 13. Such a media offering typically relates to films, music and games, which can be selected via a menu on the passenger device 20. In order to transmit the menu for selection and later the corresponding media content, a radio link between the passenger devices 20 and an on-board communication device 10 is used. The menus for selection may be displayed on the passenger device 20 for example by means of separately installed software or by calling up a web page with a browser.

In this embodiment, three passenger devices 20a, 20b, 20c are connected to the on-board communication device 10a, which devices in parallel can all access the media content which is stored in the memory unit 2 of the on-board communication device 10. The further passenger devices 20d, 20e, 20f access the media data of the on-board communication device 10b, which in this example is better positioned for the connection quality to the passenger devices 20d, 20e, 20f, via the radio unit 12.

The on-board communication devices 10 in this embodiment furthermore comprise in each case a radio module 14, with which both on-board communication devices 10 can communicate and exchange data with each other.

In an advantageous embodiment, at least one on-board communication device 10 has a connection to an on-board communication means 17. The on-board communication means 17 in this embodiment is mounted on the vehicle 13 and serves to set up an external data connection 18 to a further, possibly global, network, such as a telephone network or the Internet. Above all, satellite-aided or alternatively terrestrial mobile radio systems are suitable for this for relatively location-independent operation.

The external data connection 18 in an advantageous embodiment is routed via a wireless data connection between at least two on-board communication devices 10, as a result of which the routing on-board communication device 10 acts as a switching point. The routing may take place several times over, which means that the external data connection 18 of the on-board communication means 17 can be used by every on-board communication device 10 present in the vehicle 13. Such routing or alternatively provision of the external data connection 18 to other on-board communication devices 10 takes place in a typical embodiment via the radio modules 14 and separately from the wireless data traffic of the radio unit 12 of the on-board communication devices 10 with the passenger devices 20.

Furthermore, in this embodiment, routing of the external data connection 18 from the on-board communication devices 10 of the on-board communication system 30 to the passenger devices 20 takes place. In this manner, the passengers can utilise the external data connection 18 with their passenger devices 20, for example for telephony and Internet. The data transmission in this case may take place in parallel with the transmission of the media data via the wireless data access point. The on-board communication device 10 in this case also acts as a switching unit, with, in a preferred embodiment, changing or routing of the wireless radio link from the radio module 14 to the radio unit 12 taking place.

By this switching of the external data connection 18, a passenger device 20 can utilise the access to the external data connection 18 via the on-board communication device 10 which is most favourably located in terms of its position.

In the embodiment illustrated in FIG. 3, at least one on-board communication device 10 has an operator terminal 19. This operator terminal 19 may be located in a cabled connection in the vicinity of an on-board communication device 10, as a result of which the on-board staff can suitably influence the operating behaviour of the on-board communication device 10 and also of the entire on-board communication system 30.

In a possible embodiment, the operator terminal 19 is installed in the passenger compartment and connected wirelessly and/or by cable to at least one on-board communication device 10. In a further alternative embodiment, the operator terminal 19 is a mobile device which is connected wirelessly to at least one on-board communication device 10, and can be carried with them by the on-board staff, similarly to a remote control.

FIG. 4 illustrates a diagrammatic representation of an on-board communication system 30 during an interruption in operation of the vehicle 13. A mobile media-loading unit 7 is connected to an on-board communication device 10 in this embodiment. The connection can be in this case via a data connection which is cabled or radio-based. Updated media data which is subsequently to be offered to the passengers as media content is stored on the mobile media-loading unit 7. This media data may be updated media content, or media content for a different group of expected passengers from a different linguistic and/or cultural background.

The updated media data is transferred from the media loading unit 7 into an on-board communication device 10 and stored there in the memory unit 2. An outdated data set can in so doing be deleted and/or overwritten.

The corresponding on-board communication device 10 with the updated data then, or as early as during the loading operation of the media loading unit 7, carries out automatic distribution and updating on all the further on-board communication devices 10 located in the vehicle 13. In a possible embodiment, direct mirroring of the data in the memory unit 2 of the on-board communication device 10 to which the media loading unit 7 is connected takes place in order to transfer the updated media data.

The wireless data connection between the on-board communication devices 10 is preferably used exclusively for distribution during the distribution of the updated data, so that the fastest possible distribution of the data is achieved.

In an advantageous embodiment, the radio units 12 of the wireless data access points, which usually establish the connection to the passenger devices 20, are likewise used for the fastest possible distribution of the data. In the case of distribution and updating of the media data, which usually comprise a large volume of data, the passengers and hence the passenger devices 20 are typically not in the passenger compartment of the vehicle 13, so that the possible independent operation of radio modules 14 and radio units 12 can be utilised in order to increase considerably the transfer rates between the on-board communication devices 10. Once the distribution of the updated media data has concluded, the on-board communication system 30 can be switched off or set into various other operating states.

One possible operating state of the on-board communication system 30 in this embodiment is independent operation of the on-board communication devices 10 without the on-board communication devices 10 communicating with each other.

A further possible operating state of the on-board communication system 30 may include offering media data and an external data connection 18 in parallel for the passenger devices 20.

In a further possible operating state, no media content, but exclusively external data connections 18, is/are offered to the passenger devices 20.

In a possible operating state of the on-board communication system 30, all the on-board communication devices 10 are in the switched-off state. Switching off the on-board communication devices 10 is important in particular for aircrafts in critical phases of flight, such as take-off and landing. Furthermore, this is naturally useful during pauses in operation of the vehicle 13.

In a possible embodiment, the power supply 15 for the on-board communication devices 10 is used for switching on and off. This is a simple way of switching the on-board communication devices 10 on and off.

The on-board communication device 10 in an advantageous embodiment is configured regularly to be switched off by means of an unannounced interruption in the power supply 15, so that fault-free operation is possible when switching on the on-board communication device 10. The on-board communication device 10 in this embodiment is configured particularly for switching-off operations without shutting down the media server 1 and the electronic components. Furthermore, in particular the media server 1, once the power supply 15 has been switched back on, requires a certain start time until full service readiness is achieved. This start time may for example comprise the boot operation or the time to power up the electrical and/or electronic components and the corresponding loading times. The switching-on of the on-board communication device 10 once the power supply 15 has been switched off completely is also referred to as a cold start. In this advantageous embodiment, the start time is less than 2 minutes. In a further advantageous embodiment, the start time is less than 1 minute. In an alternative embodiment, the start time is less than 3 minutes.

The on-board communication device 10 in an advantageous embodiment can be controlled via a connected control line. Via the control line, switching commands can be transmitted to the on-board communication device 10, which makes partial switching-off of individual components of the on-board communication device 10, e.g. all the sending and receiving means, possible. Furthermore, various further control commands can be transmitted via the control line which permit control of the operational performance of the on-board communication device.

Furthermore, the on-board communication devices 10 in a preferred embodiment may be switched on and/or off by the power supply 15 via a ripple control. Due to the ripple control, simple commands can be transmitted to the on-board communication devices 10, which commands, in addition to switching on and/or switching off, also permit the switching-off of individual components and control of the operating functions. The control commands are for example read out by the voltage source 3 from the voltage of the power supply 15.

In a preferred embodiment, the on-board communication devices 10 can be switched on and off with a particular signal, in particular a radio signal. The switching-off may mean complete switching-off of all the components of the on-board communication device 10, or alternatively also only switching-off of the active send functions, so that electromagnetic interference on electronic components of the vehicle 13 can be avoided at times, for example upon take-off and landing. Switching-off of only the send functions furthermore makes it possible to receive signals, for example radio signals, as a result of which the on-board communication device 10 can be set back into an active operating state. For this, physical separation of the sending and receiving elements in the radio module 14 and in the radio unit 12 may be useful.

In an advantageous embodiment, the on-board communication device 10 is configured to emit a particular radio signal for switching the other on-board communication devices 10 on or off. A switching command from an operator terminal connected to said on-board communication device 10 can thereby be transmitted to all the other on-board communication devices 10 of the on-board communication system 30.

1-15. (canceled)

16. A communication device comprising:
at least one media server;
at least one wireless data access point, wherein each wireless data access point of the at least one wireless data access point comprises a radio unit of a corresponding at least one radio unit, wherein each radio unit of the at least one radio unit is configured to wirelessly transmit media data from the at least one media server to at least one passenger device; and
at least one radio module, wherein the at least one radio module is configured to wirelessly communicate with at least one additional communication device.

17. The communication device according to claim 16, wherein the at least one radio module is configured to wirelessly exchange data with the at least one additional communication device without restricting the transfer rates of wireless data transmissions between the communication device and the at least one passenger device.

18. The communication device according to claim 16, wherein a first frequency range of the at least one radio module is different from a second frequency range of the at least one radio unit.

19. The communication device according to claim 16, wherein the at least one radio module and the at least one radio unit have different channels or have different data protocols.

20. The communication device according to claim 16, wherein the communication device is configured such that (i) when the communication device is connected to an external communication link that provides an external data connection, the communication device transmits external data from the external data connection to one or more of the at least one additional communication device via the at least one radio module; and (ii) when a first additional communication device of the at least one additional communication device is connected to the external communication link, the communication device receives external data from the external data connection from the first additional communication device or from a second additional communication device of the at least one additional communication device that is communicating with the first additional communication device via the at least one radio module.

21. The communication device according to claim 20, wherein the communication device is configured to act as a switching unit for a wireless data connection between two additional communication devices of the at least one additional communication device via the at least one radio module.

22. The communication device according to claim 20, wherein the communication device is configured to act as a switching unit for at least one wireless data connection between at least one passenger device and the external communication link that provides the external data connection.

23. The communication device according to claim 16, wherein the communication device is configured to be switched on and off via at least one of the following:
a control line;
a ripple control via the power supply; and
switching the power supply on or off.

24. The communication device according to claim 16, wherein the communication device is ready for operation in less than 2 minutes once the power supply has been switched on.

25. The communication device according to claim 16, wherein the communication device is configured to switch the send function of the at least one radio unit or switch the send function of the at least one radio module on or off once a particular signal has been received.

26. The communication device according to claim 16, wherein the communication device is configured to emit a radio signal for switching the at least one radio unit or the at least one radio module of one or more additional communication device of the at least one additional communication device on or off.

27. The communication device according to claim 26, wherein the communication device is configured to identify an installation location of the communication device via coding of an installation-side plug connector to the power supply.

28. The communication device according to claim 16, wherein the communication device is configured such that updated media data is transferred into the communication device via a mobile media-loading unit.

29. The communication device according to claim 16, wherein the communication device is configured for automatic transmission of updated media data from the media server to another communication device.

30. A communication system, comprising:
a plurality of communication devices that are wirelessly connected together to form a wireless network, wherein each communication device of the plurality of communication devices comprises:
at least one media server;
at least one wireless data access point, wherein each wireless data access point of the at least one wireless data access point comprises a radio unit of a corresponding at least one radio unit, wherein each radio unit of the at least one radio unit is configured to wirelessly transmit media data from the at least one media server to at least one passenger device; and
at least one radio module, wherein the at least one radio module is configured to wirelessly communicate with each of the other communication devices of the plurality of communication devices.

31. The communication system according to claim 30, wherein each communication device of the plurality of communication devices is configured to wirelessly exchange data with the other communication devices of the plurality of communication devices without restricting the transfer rates of wireless data transmissions between the communication device and the at least one passenger device.

32. The communication system according to claim 30, wherein each communication device of the plurality of communication devices is configured such that (i) when the communication device is connected to an external communication link that provides an external data connection, the communication device transmits external data from the external data connection to one or more other communication devices of the plurality of communication devices; and (ii) when a first other communication device of the plurality of communication devices is connected to the external communication link, the communication device receives external data from the external data connection from the first other communication device of the plurality of communication devices or from a second other communication device of the plurality of communication devices that is communicating with the first other communication device of the plurality of communication devices via the at least one radio module.

33. The communication system according to claim 30, wherein each communication device of the plurality of communication devices is configured to act as a switching unit for a wireless data connection between two other communication devices of the plurality of communication devices via the at least one radio module.

34. The communication system according to claim 30, wherein each communication device of the plurality of communication devices is configured to act as a switching unit for at least one wireless data connection between at least one passenger device and the external communication link that provides the external data connection.

35. A vehicle, comprising:
a passenger compartment;
a plurality of communication devices, wherein each communication device of the plurality of communication devices comprises:
at least one media server;
at least one wireless data access point, wherein each wireless data access point of the at least one wireless data access point comprises a radio unit of a corresponding at least one radio unit, wherein each radio unit of the at least one radio unit is configured to wirelessly transmit media data from the at least one media server to at least one passenger device; and
at least one radio module, wherein the at least one radio module is configured to wirelessly communicate with each of the other communication devices of the plurality of communication devices.

36. The vehicle according to claim 35, further comprising an external communication link that provides an external data connection, wherein when a first communication device of the plurality of communication devices having a corresponding first at least one radio module of the first communication device is connected to the external communication link, a second communication device of the plurality of communication devices receives external data from the external data connection from the first communication device of the plurality of communication devices via the first at least one radio module of the first communication device.
